(19) United States
(12) Patent Application Publication
(10) Pub. No.: US 2004/0083301 A1
(43) Pub. Date: Apr. 29, 2004

(54) Method for distributing dynamic image and sound over network, the apparatus, and method for generating dynamic image and sound

(76) Inventors: Yotaro Murase, Aichi-Gun (JP); Hidematsu Kasano, Hiratsuka-Shi (JP)

Correspondence Address: JACOBSON HOLMAN PLLC, 400 SEVENTH STREET N.W., SUITE 600, WASHINGTON, DC, 20004, US

(21) Appl. No.: 10/383,884

(22) Filed: Mar. 10, 2003

Related U.S. Application Data
(63) Continuation of application No. PCT/JP00/06182, filed on Sep. 11, 2000.

(51) Int. Cl. G06F 15/16

(52) U.S. Cl. 709/231; 709/236; 709/247

(57) ABSTRACT

A system and method for interactively delivering video and/or audio data in response to a user input through a network in order to reproduce the data immediately without interruption are disclosed. A server (1) sequentially sends multiple compressed streams (s(1), s(2), s(n)) of video and/or audio data to a client (3) which sequentially receives the streams, sequentially stores the received streams into a memory independent of the server, sequentially decompresses the streams, and reproduces or displays the decompressed streams in parallel with the receiving and decompressing process.

### RELATED PATENT DOCUMENT

This application claims priority from International Application No. PCT/JP00/06182, “System and method for sending streams of video and/or audio data over network and method for creating such streams”, filed on Sep. 11, 2000, by Yotaro Murase, which is incorporated by reference herein.

### TECHNICAL FIELD

The present invention relates generally to a system and method for delivery and reproduction of continuous streams of video and/or audio data and a system and method for creating such streams, and more particularly to a system and method for interactive transmission and continuous reproduction of streams of video and/or audio data in response to a user input through a network in order to start the reproduction of the streams by means of a simple computer program with a very short lead time and without any interruption of the reproduction of the streams or skipping of frames at a client terminal and wherein the streams may be easily stored at a client terminal for later reproduction.

### BACKGROUND ART

Streaming reproduction technique is known in the art as prior art method for delivery of video and/or audio materials in which a server computer produces transmission packets containing frame data divided into video and/or audio data of streams on a frame basis to send to a client terminal. When a server computer and a client terminal are connected each other over networks, such as, public telephone networks, a negotiation will be made between the server computer and the client terminal. After the negotiation is completed, sending and receiving streams are started. After buffering or storing data for a predetermined time period which is called as a lead time, for example, four to five seconds, in order to avoid interruption of the reproduction of streams or skipping of frames at a client terminal, the reproduction of streams is started at a client terminal. Since sending a stream from a server computer and reproduction of a stream at a client terminal are synchronized, a server computer sends each frame with timing data to a client terminal in order to synchronize the server computer with the client terminal. Then, a client terminal reproduces each of decompressed frames at each time determined by the timing data. A transmission program at a server computer controls the timing of the reproduction frame by frame basis at a client terminal.

The streaming reproduction technique allows a client terminal to reproduce video and/or audio material only when receiving the video and/or audio material from a server but can not allow a client terminal to store the video and/or audio material in order to reproduce it again later on by itself.

Since the amount of data in a frame defers frame by frame, there is a large difference in the amount of stream data in frames compressed by a well-known variable bit rate compression method, and the synchronization between transmission and reproduction is made based on a maximum frame data, it is necessary for a packet to contain staffing byte if a frame is too small to fill the packet so as to unify the time taken for sending each of frames to a client terminal in order to synchronize the transmission from a server with the reproduction at a client. Therefore, the performance of transmission is deteriorated.

When using an interframe predictive coding technique to compress a stream, a client terminal needs to wait for receiving a group of frame data in order to start decompression. Therefore, a buffering time or lead time between the start of receiving data and the start of reproduction of data at a client terminal must be long enough to avoid interruption of the reproduction or skipping of frames. When using a network having sufficiently broad bandwidth or an ATM network, the time taken for sending every frame from a server computer to a client terminal would be kept at a constant time period irrespective of the amount of code in a frame and the quality of reproduction at a client terminal would be good. However, when using a narrow bandwidth network, such as a public telephone line, the reproduction of video and/or audio data at a client terminal is not practical for wide use because of the limited quality of the reproduction.

In the prior art method, since an application program directly receives packets from a server computer without using communication protocols at lower layers, it usually takes several seconds for a negotiation between a server computer and a client terminal for each stream. Therefore, the prior art method is not possible for use in an interactive system in which a server computer needs to immediately send a stream to a client terminal for reproducing the streams at the client terminal in response to a user input which is to be sent from the client terminal at any time. Moreover, the prior art method is not possible to immediately restart the reproduction of a stream after a pause of the reproduction. Even if sending streams to a client terminal through a broad bandwidth network in the prior art method, transmission performance would not be improved because a buffering time or a lead time and negotiation time can not be eliminated. Moreover, as mentioned above, a client terminal can not reproduce the received streams later on since the received streams can not be stored in the client terminal. Therefore, applications for the prior art method are limited.

Progressive downloading is known in the art as another prior art method in which a stream which can be reproduced independently is downloaded from a sever computer to a RAM disk of a client terminal. The progressive downloading starts to reproduce a stream at a client terminal in parallel with receiving and decompression processes of a stream when a certain amount of data is downloaded into a client terminal. Video and/or audio data can be reproduced at the client terminal with the same quality at a server computer and also can be reproduced again later on. In this prior art method, however, the relationship between the time taken for receiving a stream and the time taken for reproducing the stream is not certain if the stream is compressed with a variable bit rate method. Therefore, it is uncertain about an appropriate time period from the start of receiving a stream to the start of reproducing the stream, that is, a lead time, at a client terminal to avoid interruption during the reproduction of the stream. Thus, a client terminal needs to choose a lead time long enough to ensure to avoid any interruption of the reproduction of the stream, particularly, for a long stream. Nonetheless, if a client terminal receives a very long stream, the reproduction of the long stream at the client terminal tends to be interrupted. After the interruption, a user operation, such as, mouse clicking, is necessary to restart the reproduction of the stream.

In addition, in the prior art method, since sending and receiving a stream and reproducing the stream are not synchronized, a client terminal can not process a user input in accordance with the stream being reproduced at the client terminal. Therefore, an interactive system in which a server needs to send a next stream to a client terminal in response to a user input at the client terminal is not possible in this prior art method.

In both of the streaming reproduction method and progressive downloading method, all of the processes of sending a stream from a server computer to a client terminal in response to a user request, receiving the stream at the client terminal, decompression and reproduction of the stream at the client terminal are unified. Therefore, the types of streams for use in the prior art methods are limited to those defined by each of the method.

As explained above, since the prior art methods require the time for negotiation in order to send video and/or audio data from a server to client and a buffer time (a lead time) for storing data after receiving a stream and before reproducing the stream at a client terminal so as to prevent from interruption of the reproduction of a stream or skipping of frames, a user at a client terminal has to wait for a long time before starting the reproduction of a stream. Moreover, since a program which synchronizes the transmission of video and/or audio data from a server with the reproduction or display of video and/or audio data at a client is complex in the prior art methods, the computational resources in a server computer and a client terminal tend to be overloaded. Furthermore, it is impossible for the prior art methods to effectively deliver a particular stream of high resolution or high frame rate of display over a narrow bandwidth network to a client without any interruption of the reproduction of the display or any skipping of frames. Furthermore, it is difficult for the prior art methods to interactively select video and/or audio data in response to a user input at a client in order to send and reproduce the selected video and/or audio data at a client without any interruption of the reproduction or skipping frames. Furthermore, it is not possible for the prior art streaming reproduction method to store received video and/or audio data at a client for later reproduction.

### DISCLOSURE OF INVENTION

Therefore, it is an objective of the present invention to solve the above-mentioned drawbacks of the prior art methods by providing a system and method for creating and sending multiple streams (including streams compressed with variable bit rate) of video and/or audio data to be continuously reproduced or displayed from a sever computer to a client terminal in which the streams can be reproduced almost immediately after the receiving at the client terminal independent of the server computer and the streams can be effectively sent from the server and stored at the client for later reproduction or display.

It is another object of the present invention to provide a system and method for creating, compression/decompression, sending and reproduction of streams of video and/or audio data in which any stream can be reproduced with a higher definition of images and/or a higher quality of sounds than the other streams without interruption of the reproduction or skipping.

It is still another object of the present invention to provide a system and method for selective and synchronized transmission and reproduction of streams of video and/or audio data from a server computer to a client terminal in response to a user input so that the reproduction of the streams of video and/or audio data at the client terminal smoothly and quickly responds to the user input.

It is still another object of the present invention to provide a system and method for sending streams of video and/or audio data from a sever computer of general purpose to a client terminal by using a program of very small size and any type of operating systems and any type of protocols with high portability in which the streams can be compressed with any type of compression method as long as a compressed stream can be decompressed and reproduced alone and can be delivered over a narrow bandwidth network in real time with high resolution of images and/or high quality of sounds of the streams.

In accordance with one aspect of the present invention, there is provided a method for sending multiple compressed streams of video and/or audio data from a server computer to a client terminal through a network for reproducing the streams at the client terminal, comprising the steps of sequentially sending the streams from the server computer to the client terminal, sequentially receiving the sent streams at the client terminal, storing the received streams into a memory in the received order at the client terminal independently of the server computer, decompressing sequentially the stored streams, and reproducing or displaying the decompressed streams in parallel with the receiving and decompressing of the streams.

According to this method of the present invention, the multiple streams of video and/or audio data can be effectively delivered and reproduced with a simple program without any special synchronization mechanism between a server computer and a client terminal by merely sequentially sending the streams from the server computer to the client terminal, sequentially receiving the sent streams at the client terminal, storing the received streams into a memory in the received order at the client terminal independent of the server computer, sequentially decompressing the stored streams and reproducing or displaying the streams at the client terminal in parallel with the receiving and the decompression.

The method according to the present invention may further comprise the steps of sending a signal from a client terminal to a sever computer each time when the reproduction or the display of a stream starts or ends at the client terminal, and when the signal is received by the server computer, the server computer starts the step of sequentially sending the compressed streams from the server computer. According to this method of the present invention, the synchronization between the transmission of streams from a server computer and the reproduction or display of streams at the client terminal can be attained easily.

The method according to the present invention may further comprise the steps of including an identifier in each of the streams indicating the connecting relationship among the streams for use in a client terminal to receive and sequentially store the streams into the memory.

In accordance with another aspect of the present invention, there is provided a method for sending a plurality of compressed streams of video and/or audio data from a server computer to a client terminal through a network and reproducing the streams at the client terminal, comprising the steps of sending a first stream from the server computer to the client terminal, receiving the first stream at the client terminal, decompressing and reproducing or displaying the first stream at the client terminal immediately after the receiving the first stream, sending a second stream from the server computer immediately after sending the first stream, receiving and decompressing the second stream at the client terminal during the reproduction or display of the first stream, reproducing or displaying the second stream immediately after the reproduction or display of the first stream at the client terminal without interruption, and sequentially repeating the above steps for following streams, wherein there are first relationship [Dt(1)+c(1)]>[t(2)+c(2)] in which Dt(1) is time taken for reproducing or displaying the first stream at the client terminal, c(1) is time taken for decompressing the first stream at the client terminal, t(2) is time taken for sending the second stream from the server computer and receiving the second stream at the client terminal, and c(2) is time taken for decompressing the second stream at the client terminal, and second relationship [t(n)+c(n)]<[T(n−1)+c(1)−T′(n−1)] in which “n” is an integer more than two, t(n) is time taken for sending a nth stream from the server computer and receiving the nth stream at the client terminal, c(n) is time taken for decompressing the nth stream, T(n−1) is time taken for reproducing or displaying from the first stream to (n−1)th stream at the client terminal, c(1) is time taken for decompressing the first stream at the client terminal, and T′(n−1) is time taken for sending the second stream through the (n−1)th stream from the server computer and receiving the second stream through the (n−1)th stream at the client terminal.

According to this method of the present invention, a client terminal can start the reproduction or display of the streams of video and/or audio data immediately after receiving the first stream by reducing the amount of data in the first stream and continue to smoothly reproduce or display following streams without interruption of the reproduction, skipping frames or any glitch.

In accordance with still another aspect of the present invention, there is provided a method for creating multiple compressed streams of video and/or audio data to be sent from a server computer to a client terminal through a network for reproducing the streams at the client terminal, comprising the step of creating the streams so that a nth stream of the streams has an average data rate R(n) after compression which has relationship, R(n)≦{[T(n−1)+c(1)−c(n)]W−B(n−1)−H}/Dt(n), in which “n” is an integer more than one, T(n−1) is time taken for reproducing or displaying from a first stream through a (n−1)th stream of the streams at the client terminal, c(1) is time taken for decompressing the first stream at the client terminal, c(n) is time taken for decompressing the nth stream at the client terminal, W is an effective transmission speed of the network, B(n−1) is the number of total bytes included from a second stream to the (n−1)th stream (when n=2, B(1)=0), H is the number of additional bytes added separately, such as, header bytes, and Dt(n) is time taken for reproducing or displaying the nth stream at the client terminal.

According to this method of the present invention, a client terminal can start the reproduction or display of the streams of video and/or audio data with a minimum waiting time after receiving a first stream and continue to smoothly reproduce or display following streams without any interruption of the reproduction, skipping frames or glitch.

In accordance with still another aspect of the present invention, there is provided a method for creating multiple compressed streams of video and/or audio data to be sent from a server computer to a client terminal through a network for reproducing one of the streams with a higher quality or higher frame rate than the other streams at the client terminal, comprising the steps of: if a second stream is the one of streams to be reproduced with a higher quality or higher frame rate than the other streams, creating a first stream and the second stream so that an average data rate after compression of the first stream is lower than an effective transmission speed W of the network, and that the value of [Dt(1)+c(1)] is large in which Dt(1) is time taken for reproducing or displaying the first stream at the client terminal and c(1) is time taken for decompressing the first stream at the client terminal in order to make an average data rate after compression of the second stream higher than the effective transmission speed W of the network, and, if a nth stream of the streams(“n” is an integer more than 2) is the one stream to be reproduced with a higher quality or higher frame rate than the other streams, creating the first stream through the nth stream so that the value of [T(n−1)+c(1)−T′(n−1)] is large in which T(n−1) is time taken for reproducing or displaying from the first stream through a (n−1)th stream at the client terminal, c(1) is time taken for decompressing the first stream at the client terminal, and T′(n−1) is time taken for sending the second stream through the (n−1)th stream from the server computer and receiving them at the client terminal in order to make an average data rate of the nth stream after compression higher than the effective transmission speed W of the network.

According to this method of the present invention, a server computer can send one or several streams to a client terminal over a network of a limited bandwidth for reproducing or displaying the one of streams or several streams with a high quality or high frame rate than the other streams.

In accordance with still another aspect of the present invention, there is provided a method for sending multiple compressed streams of video and/or audio data from a server computer to a client terminal through a network for reproducing the streams at the client terminal, comprising the step of sending the streams from the server computer to the client computer so that there is relationship [t(n)+c(n)]<[Dt(n−1)−p] in which “n” is an integer more than one, t(n) is time taken for sending a nth stream of the streams from the server computer and receiving the nth stream at the client terminal, c(n) is time taken for decompressing the nth stream at the client terminal, Dt(n−1) is time taken for reproducing or displaying a (n−1)th stream of the streams at the client terminal, and “p” is time taken for sending a signal from the client terminal to the server computer.

According to this method of the present invention, synchronization between sending streams from a server computer and reproducing or displaying streams at a client terminal can be attained by a simple method so as to avoid overflow of the streams at the client terminal in order to accomplish an interactive system in which video and/or audio data can be interactively sent and reproduced at a client terminal in response to a user input or in accordance with a user choice.

In accordance with still another aspect of the present invention, there is provided a method for creating multiple compressed streams of video and/or audio data to be sent from a server computer to a client terminal through a network, comprising the step of creating the streams so that there is relationship R(n)≦{Dt(n−1)−p−c(n)]W−h}/Dt(n) among the streams in which “n” is an integer more than one, R(n) is an average data rate of a nth stream of the streams after compression, Dt(n−1) is time taken for reproducing or displaying a (n−1)th stream of the streams at the client terminal, “p” is time taken for sending a signal from the client terminal to the server computer, c(n) is time taken for decompressing the nth stream, W is an effective transmission speed of the network, “h” is the number of additional bytes added separately, such as, header bytes, and Dt(n) is time taken for reproducing or displaying the nth stream at the client terminal.

According to this method of the present invention, synchronization between sending streams from a server computer and reproducing or displaying streams at a client terminal can be attained by a simple method so as to avoid overflow of the streams at the client terminal or to make interactive contents in which video and/or audio data can be sent to a client terminal in response to a user input or in accordance with a user choice.

In accordance with still another aspect of the present invention, there is provided a method for creating multiple compressed streams of video and/or audio data to be sent from a server computer to a client terminal through a network for reproducing a nth stream of the streams with a relatively high quality or relatively high frame rate at the client terminal, comprising the step of creating the streams so that there is relationship, Dt(n−1)>[t(n−1)+c(n−1)], among the streams in which “n” is an integer more than one, Dt(n−1) is time taken for reproducing or displaying a (n−1)th stream of the streams at the client terminal, t(n−1) is time taken for sending the (n−1)th stream from the server computer and receiving it at the client terminal, c(n−1) is time taken for decompressing the (n−1)th stream at the client terminal in order to make t(n) which is time taken for sending the nth stream from the server computer and receiving the nth stream at the client terminal longer than Dt(n) which is time taken for reproducing or displaying the nth stream at the client terminal.

According to this method of the present invention, a part of interactive contents sent from a server computer to a client terminal through a network can be created so as to be reproduced with a relatively high quality or high frame rate in comparison with the other part of interactive contents at the client terminal.

In accordance with still another aspect of the present invention, there is provided a method for sending plural “n” streams of multiple compressed video and/or audio data from a server computer to a client terminal through a network for reproducing the streams at the client terminal in which “n” is an integer more than one, comprising the step of storing the streams sent from the sever computer at the client terminal for a time period equal to or longer than “g” after receiving a first stream of the streams from the server computer and before reproducing the first stream at the client terminal, wherein “g” is the largest value of differences A(n)=[Tt(n)+c(n)−T(n−1)] for all of “n” in which Tt(n) is time taken for sending the first stream through a nth stream from the server computer and receiving them at the client terminal, c(n) is time taken for decompressing the nth stream at the client terminal, and T(n−1) is time taken for reproducing or displaying the first stream through a (n−1)th stream of the streams at the client terminal.

According to this method of the present invention, video and/or audio data can be smoothly reproduced or displayed at a client terminal over a network without any interruption and with a minimum waiting time or a lead time.

In accordance with still another aspect of the present invention, there is provided a computer readable recording medium for storing computer program means to send multiple compressed streams of video and/or audio data from a server computer to a client terminal through a network for reproducing the streams at the client terminal, comprising computer program means for implementing the steps of sequentially sending the streams from the server computer to the client terminal, sequentially receiving the streams at the client terminal, storing the received streams into a memory in the received order at the client terminal independently of the server computer, decompressing sequentially the stored streams, and reproducing or displaying the decompressed streams in parallel with the receiving and decompressing of the streams.

According to this computer readable recording medium of the present invention, video and/or audio data can be smoothly reproduced or displayed at a client terminal over a network after a minimum waiting time and without any interruption or glitch. In addition, the video and/or audio data can be reproduced again and again later on at the client terminal.

This computer readable recording medium according to the present invention may further comprise computer program means for implementing the steps of sending a signal from a client terminal to a sever computer each time when the reproduction or the display of a stream starts or ends at the client terminal, and after the signal received by the server computer, the server computer starting the step of sequentially sending the compressed stream from the server computer. According to this computer readable recording medium of the present invention, the synchronization between the transmission of streams from a server computer and the reproduction or display of streams at the client terminal can be attained easily.

In accordance with still another aspect of the present invention, there is provided a computer readable recording medium for storing multiple compressed streams of video and/or audio data to be sent from a server computer to a client terminal through a network for reproducing the streams at the client terminal, comprising the streams which are created so that a nth stream of the streams has an average data rate R(n) after compression having the following relationship, R(n)≦{[T(n−1)+c(1)−c(n)]W−B(n−1)−H}/Dt(n), in which “n” is an integer more than one, T(n−1) is time taken for reproducing or displaying from a first stream through a (n−1)th stream of the streams at the client terminal, c(1) is time taken for decompressing the first stream at the client terminal, c(n) is time taken for decompressing the nth stream at the client terminal, W is an effective transmission speed of the network, B(n−1) is the number of total byte included from a second stream to the (n−1)th stream (when n=2, B(1)=0), H is the number of additional bytes added separately, such as, header bytes, and Dt(n) is time taken for reproducing or displaying the nth stream at the client terminal.

According to this medium of the present invention, a client terminal can start the reproduction or display of the streams of video and/or audio data with a minimum waiting time after receiving a first stream and continue to smoothly reproduce or display following streams without any interruption of the reproduction, skipping frames or glitch.

In accordance with still another aspect of the present invention, there is provided a system for sending multiple compressed streams of video and/or audio data from a server computer to a client terminal through a network for reproducing the streams at the client terminal, comprising means for sending the streams from the server computer to the client computer so that there is relationship [t(n)+c(n)]<[Dt(n−1)−p] in which “n” is an integer more than one, t(n) is time taken for sending a nth stream of the streams from the server computer and receiving the nth stream at the client terminal, c(n) is time taken for decompressing the nth stream at the client terminal, Dt(n−1) is time taken for reproducing or displaying a (n−1)th stream of the streams at the client terminal, and “p” is time taken for sending a signal from the client terminal to the server computer.

According to this system of the present invention, synchronization between sending streams from a server computer and reproducing or displaying streams at a client terminal can be attained by a simple means so as to avoid overflow of the streams at the client terminal in order to accomplish an interactive system in which video and/or audio data can be sent and reproduced at the client terminal in response to a user input.

In accordance with still another aspect of the present invention, there is provided a system for sending plural “n” streams of multiple compressed video and/or audio data from a server computer to a client terminal through a network for reproducing the streams at the client terminal in which “n” is an integer more than one, comprising means for storing the streams sent from the sever computer at the client terminal for a time period equal to or longer than “g” after receiving a first stream of the streams from the server computer and before reproducing the first stream at the client terminal, wherein “g” is the largest value of differences A(n)=[Tt(n)+c(n)−T(n−1)] for all of “n” in which Tt(n) is time taken for sending the first through a nth streams from the server computer and receiving at the client terminal, c(n) is time taken for decompressing the nth stream at the client terminal, and T(n−1) is time taken for reproducing or displaying the first through a (n−1)th streams at the client terminal.

According to this method of the present invention, video and/or audio data can be smoothly reproduced or displayed at a client terminal over a network without any interruption and with a minimum waiting time or a lead time.

### BRIEF DESCRIPTION OF DRAWINGS

A better understanding of the present invention can be obtained when the following detailed description of the preferred embodiment is considered in conjunction with the drawings, in which:

FIG. 1 illustrates a schematic overview of a video and/or audio data delivery system of the present invention;

FIG. 2 illustrates streams of video and/or audio data and time chart of sending, decompression and reproduction of the streams to explain a method for sending streams from a server to a client of according to a first preferred embodiment of the present invention;

FIG. 3 illustrates streams of video and/or audio data and time chart of sending, decompression and reproduction of the streams to explain a method for sending streams from a server to a client of according to a second preferred embodiment of the present invention;

FIG. 4 illustrates streams of video and/or audio data and time chart of sending, decompression and reproduction of the streams to explain a method for sending streams from a server to a client according to a third preferred embodiment of the present invention;

FIG. 5 illustrates an operation of computer program for delivery and reproduction of the streams according to the present invention;

FIG. 6 illustrates a computer program according to the present invention with a structure of computer software and hardware;

FIG. 7A illustrates a flow chart of operations for receiving, decompression and reproduction of streams by a computer program according to the present invention at a client computer;

FIG. 7B illustrates memory contents at a client terminal according to the present invention;

FIG. 8A illustrates a flow chart of another operations for receiving and decompression of streams by a computer program according to the present invention at a client computer;

FIG. 8B illustrates a flow chart of another operations for reproduction of streams by a computer program according to a present invention;

FIG. 9 illustrates a flow chart of operations for display of streams by a computer program at a client terminal according to the present invention at a client computer;

FIG. 10 illustrates a timing chart of a method for interactively sending streams according to one embodiment of the present invention; and

FIG. 11 illustrates a timing chart of a method for interactively sending streams according to another embodiment of the present invention

### BEST MODE FOR CARRYING OUT THE INVENTION

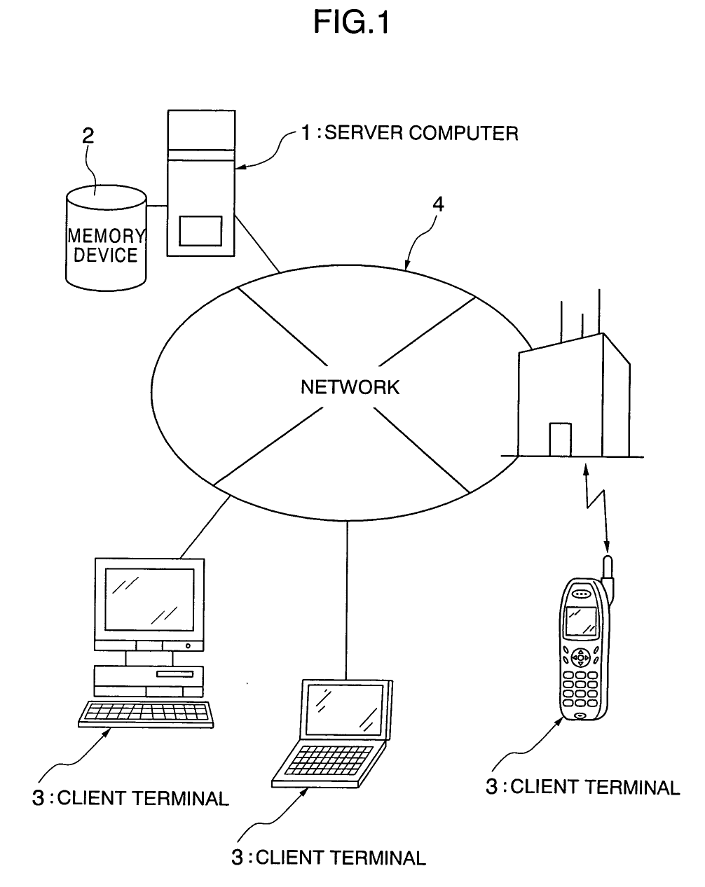

Referring now to FIG. 1, a video and/or audio data delivery system according to a first embodiment of the present invention is shown. In the first embodiment, the system uses multiple streams of video and/or audio source data. Each of the streams is divided into a predetermined time length, compressed at a predetermined data rate, and stored into a memory device 2 of a sever computer 1. When a client terminal 3 requests the server computer 1 for video and/or audio data delivery through a network 4, the server computer 1 sequentially sends the streams to the client terminal through the network 4. The network 4 may be the Internet, wired public telephone network, or wireless cellular phone network. The client terminal 3 connected to the network 4 may be, for example, a personal computer of desktop type, a personal computer of notebook type, a personal digital cellular phone with computer function or a personal digital assistance.

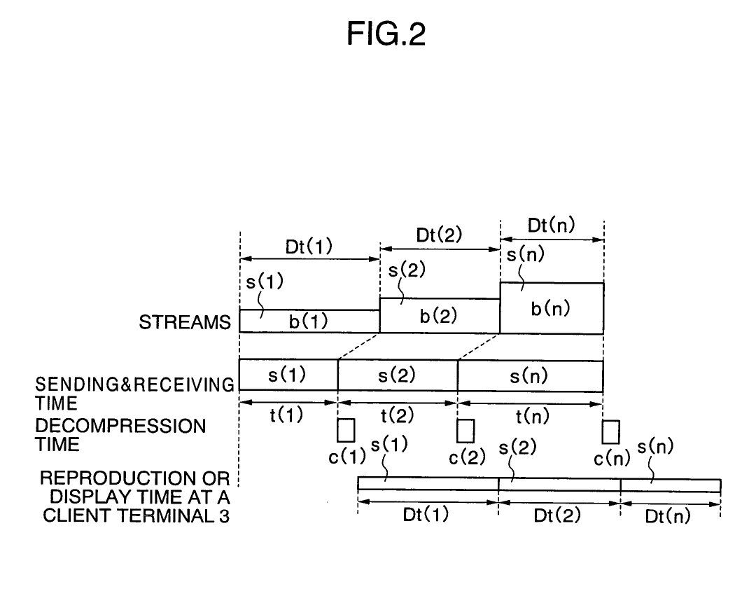

In order to create compressed multiple streams s(1), s(2), . . . , s(n) (FIG. 2)of video and/or audio data, source video and/or audio data stored in tapes or disks is firstly loaded into a computer by compressing with intraframe coding method. Then, the compressed source video and/or audio data is divided into multiple parts. The video data is compressed with any appropriate compression method, such as, Sorenson Video and the audio data is also compressed with any appropriate compression method, such as, IMA, in order to reduce to an appropriate data size explained hereinafter and then the compressed video and/or audio data is transformed into multiple streams s(1), s(2), . . . , s(n) with an appropriate format, such as, QuickTime. The streams are then stored into the memory device 2 of the server computer 1. The streams may be compressed with any other appropriate compression method, such as, variable bit rate method using intraframe predictive coding and interframe predictive coding.

In this specification, a stream means a unit of compressed multiple video and/or audio data. A stream can be created by compressing individually after dividing source video and/or audio data into parts by a predetermined time period as mentioned above. Alternatively, a stream can be created by compressing source data as a whole without dividing into parts by a predetermined time period if the data rate of the resultant compressed stream can be selected for source data by source data. A stream is a unit for sending from a server computer 1 and also a unit for decompression at a client terminal 3. Therefore, a stream is sometimes also called as a decompression unit hereinafter. As explained in detail hereinafter, multiple streams (or decompression units) are sequentially sent from a server computer 1 to a client terminal 3 by file transfer method according to the first embodiment of the present invention.

In the first embodiment of the present invention, the client terminal 3 decompresses and reproduces a first(start) stream immediately after receiving the first stream from the server computer 1. The server computer 1 sends a second stream to the client terminal 3 immediately after sending the first stream. The client terminal 3 receives and decompresses the second stream during the reproduction of the firs stream and continuously reproduces the second stream immediately after completing the reproduction of the first stream without any interruption. The same processes are repeated for a third and following streams. The client terminal can smoothly reproduce video and/or audio data without any interruption of the reproduction or skipping frames.

As shown in FIG. 2, the streams are compressed, sent, decompressed and reproduced in order to attain continuous reproduction at a client terminal.

In FIG. 2, t(n) is time taken for sending and receiving a nth stream (“n” is a natural number). c(n) is time taken for decompressing the nth stream and preparation for reproduction or display at a client terminal. Dt(n) is time taken for reproducing or displaying the nth stream at a client terminal. b(n) is the number of bytes included in the nth stream. R(n) is an average data rate set for the nth stream. H is the number of additional bytes, such as, header byte. W is an effective transmission speed of the network 4 used for delivery.

The server computer 1 sends the first stream s(1) after receiving a request from the client terminal 3. The client terminal 3 receives the first stream s(1) within time t(1) and stores the first stream s(1) into a memory (not shown) of the client terminal 3. After receiving the first stream s(1), the client terminal decompresses the first stream s(1) within time c(1) and reproduces or displays the first stream s(1). The server computer 1 sends the second stream s(2) immediately after completing the sending of the first stream s(1). The client terminal 3 receives the second stream s(2) during the decompression time c(1) and/or the reproduction time Dt(1) of the first stream s(1) in parallel with these processes. Then, the client terminal 3 continuously reproduces or displays the decompressed second stream s(2) immediately after the completion of the reproduction or display of the first stream S(1). Then, these steps for continuously reproducing or displaying a succeeding stream immediately after the completion of reproduction or display of a preceding stream without any interruption are repeated for following streams.

Alternative method for decompression and reproduction, each of the received streams is decompressed and loaded into a display buffer in the received order at the client terminal 3. Then, the display starts sequentially from the first frame data in the display buffer with a predetermined timing as if displaying a single stream.

In order to continuously reproduce or display a succeeding stream immediately after the completion of reproduction or display of a preceding stream without any interruption at a client terminal, it needs to satisfy a condition that the receiving and decompression of the succeeding stream should be completed at the client terminal when the reproduction or display of the preceding stream is completed.

In order to satisfy the above-mentioned condition, as seen from FIG. 2 where time taken for each process of sending, receiving, decompressing, and reproducing is schematically shown by a length of a rectangular box, relationship [t(n)+c(n)]<[T(n−1)+c(1)−T′(n−1)] needs to be met in which “n” is an integer more than two, t(n) is time taken for sending and receiving a nth stream in the streams, c(n) is time taken for decompressing the nth stream at the client terminal 3, T(n−1) is time taken for reproducing or displaying from the first stream s(1) through a (n−1)th stream s(n−1) at the client terminal 3

$$( T ( n - 1 ) = {\sum }_{i = 1}^{n - 1}$$

Dt(i) where Dt(i) is time taken for reproducing or displaying an i-th stream), c(1) is time taken for decompressing the first stream at the client terminal, and T′(n−1) is time taken for sending and receiving from the second stream s(2) to the (n−1)th stream

$$( {T}^{′} ( n - 1 ) = {\sum }_{i = 2}^{n - 1}$$

t(i) where t(i) is time taken for sending and receiving the i-th stream).

As for n=2, that is, a second stream s(2), the sum [t(2)+c(2)] of time t(2) taken for sending a second stream from a server computer and receiving a second stream at a client terminal and time c(2) taken for decompressing a second stream at a client terminal needs to be smaller than the sum [Dt(1)+c(1)] of time Dt(1) taken for reproducing or displaying a first stream at a client terminal and time c(1) taken for decompressing a first stream at a client terminal. In other words, a second stream s(2) needs to be sent from a server computer to a client terminal with the sending, receiving, decompressing and reproducing processes satisfying the relationship [t(2)+c(2)]<[Dt(1)+c(1)].

In order to satisfy the above relationship, when creating a nth stream (“n” is an integer more than two) by compressing a nth divided video and/or audio data, the average data rate R(n) of the nth stream s(n) needs to be set to satisfy the following relationship R(n)<{W[T(n−1)+c(1)−c(n)]−B(n−1)H}/Dt(n), in which W is an effective transmission speed of a network being used, T(n−1) is a total reproduction or display time from a first stream s(1) to a (n−1)th stream s(n−1) at a client terminal, that is,

$$T ( n - 1 ) = {\sum }_{i = 1}^{n - 1}$$

Dt(i), c(1) is time taken for decompressing a first stream at a client terminal, c(n) is time taken for decompressing a nth stream at a client terminal, B(n−1) is the number of total bytes including from a second stream s(2) through a (n−1)th stream s(n−1), that is,

$$B ( n - 1 ) = {\sum }_{i = 2}^{n - 1}$$

b(i), When n=2, B(2−1)=B(1)=0. H is additional bytes separately added to a stream, such as, header byte, and Dt(n) is time taken for reproducing or displaying a nth stream at a client terminal.

In other words, when creating a nth stream s(n) by compressing source data, an average data rate R(n) of a nth stream s(n) needs to be set to satisfy the following Equation 1.

$$R ( n ) < \frac{W [ {\sum }_{i = 1}^{n - 1} D t ( i ) + c ( 1 ) - c ( n ) ] - {\sum }_{i = 2}^{n - 1} b ( i ) - H}{D t ( n )} \qquad Equation 1$$

If a particular stream s(n) is desired to have a higher quality in reproduction or a higher frame rate in display than other streams (“n” is an integer more than two.), an average data rate R(n) of this particular stream s(n) needs to be he higher than an effective transmission speed W of a network used.

In order to attain this, a first stream s(1) through a (n−1)th stream need to be created so that the time represented by the equation [T(n−1)+c(1)T′(n−1)] become longer. In the above equation, T(n−1) is time taken for reproducing or displaying from a first stream s(1) to a (n−1)th stream, that is,

$$T ( n - 1 ) = {\sum }_{i = 1}^{n - 1}$$

Dt(i), c(1) is time taken for decompressing a first stream at a client terminal, and T′(n−1) is time taken for sending from a server computer and receiving at a client terminal from a second stream s(2) to a (n−1)th stream, that is,

$${T}^{′} ( n - 1 ) = {\sum }_{i = 2}^{n - 1}$$

t(i). In other words, when creating from streams s(2) to s(n−1) by compression, data rates of streams s(2) to s(n−1) need to be set lower than an effective transmission speed W of a network being used.

Therefore, a nth stream s(n) can make its sending and receiving time t(n) longer than its reproduction or display time Dt(n) and an average data rate R(n) of the nth stream s(n) can be set higher than an effective transmission speed W of a network being used when creating the nth stream s(n). Accordingly, the particular stream s(n) can have a higher quality in reproduction or a higher frame rate in display than other streams.

If a second stream s(2) is desired to have a higher quality in reproduction or a higher frame rate in display than other streams, an average data rate R(1) after compression of a first stream s(1) is set to be lower than an effective transmission speed W of a network being used so that the time represented by the equation [Dt(1)+c(1)] becomes longer. In the equation, Dt(1) is time taken for reproducing or displaying a first stream s(1) and c(1) is time taken for decompressing a first stream s(1). Accordingly, a second stream s(2) can have a higher quality in reproduction or higher frame rate by setting an average data rate R(2) of the second stream s(2) after compression higher than an effective transmission speed W of a network being used.

As shown in FIG. 2, if a plurality of streams s(1), s(2), . . . , s(n) of video and/or audio data are created as explained before and sent from a server computer 1 to a client terminal 3, the plurality of streams s(1), s(2), . . . , s(n) can be continuously reproduced or displayed at a client terminal 3 without any interruption.

Actual data rate of a stream resulting from compression operation may be different from a data rate which is calculated and set as explained before. In this case, compression operation needs to be repeated until a resultant data rate after compression becomes or nears the calculated or set data rate.

Since an effective transmission speed W of a network being used may vary with environment of network, hardware and software, an effective transmission speed W is determined by testing a network to be used under actual environment of network, hardware and software.

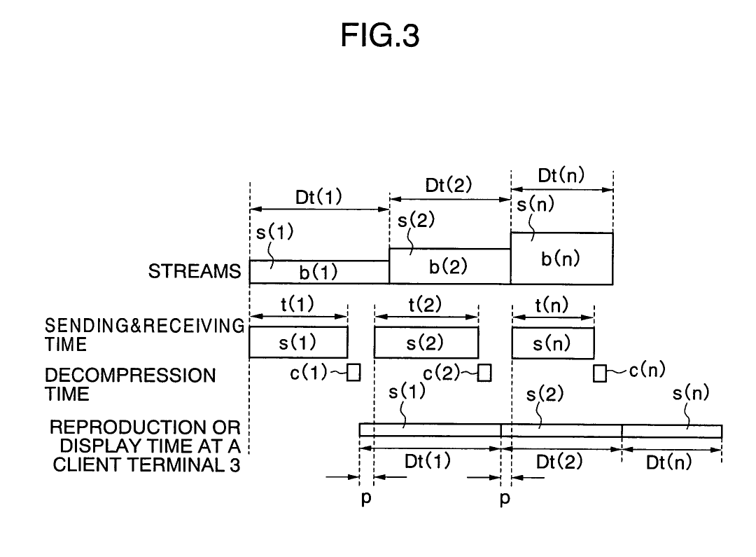

Referring now to FIG. 3, a second embodiment of the present invention is explained. In the second embodiment, a server computer sends a stream in synchronization with reproduction of a stream at a client terminal by sending a stream to a client terminal when receiving a signal from a client terminal.

In the first embodiment explained before, a server computer 1 sends streams to a client terminal asynchronously. Since a server computer 1 continuously sends each of streams, the number of streams which have been received but not yet reproduced at a client terminal 3 is uncertain and could be too large to store in the client terminal. The second embodiment solves this problem.

In addition, according to the second embodiment of the present invention, an interactive system for delivery of video and/or audio data can be made. Such an interactive system is disclosed by Japanese patent application No. 10-172701 or an international patent application PCT/JP/99/07116 in which sending a stream from a server computer needs to be synchronized with reproduction of a stream at a client terminal so that a server computer selects and sends a next stream in response to a user input during the reproduction of stream at a client terminal.

In the second embodiment of the present invention, a client terminal 3 sends a signal having several bytes to a server computer 1 each time when the client terminal 3 starts or ends reproduction of streams. A server computer 1 starts transmission of a next stream when receiving the signal from the client computer 3.

In the second embodiment of FIG. 3, a client terminal 3 reproduces a first (start) stream as soon as the client 3 receives a firs stream. The client terminal 3 continuously reproduces following streams without interruption which are sent from a server computer 1 in response to the signal sent from the client terminal 3. Thus, synchronization between sending a stream from a server computer 1 and reproducing a stream at a client terminal 3 is made.

In the second embodiment, t(n) is time taken for sending and receiving a nth stream s(n), c(n) is time taken for decompressing a nth stream s(n) at a client terminal, Dt(n) is time taken for reproducing or displaying a nth stream at a client, b(n) is the number of bytes included in a nth stream s(n), “h” is the number of additional bytes, such as, header bytes, W is an effective transmission speed of a network being used, and “p” is time taken for sending a signal from a client terminal 3 to a server computer 1.

A client terminal 3 sends a signal having several bytes to a sever computer 1 when the client terminal 3 starts reproduction of a (n−1)th stream s(n−1) which has been received and decompressed at the client terminal 3 so that the server computer 1 sends a nth (next) steam s(n) to the client terminal 3 in synchronization with the reproduction of the (n−1)th (previous) stream s(n−1) at the client terminal 3. In order to continuously reproduce streams without interruption, receiving and decompression processes of a nth (next) stream s(n) needs to be completed at the client terminal when reproduction of a (n−1)th (previous) stream is completed at the client terminal 3.

Accordingly, the relationship [t(n)+c(n)]<[Dt(n−1)-p] must be satisfied. That is, the sum of time t(n) taken for sending and receiving a nth stream s(n) and time c(n) taken for decompressing a nth stream s(n) at a client terminal is shorter than the difference between time Dt(n−1) taken for reproducing or displaying a (n−1)th stream at a client terminal and time p taken for sending a signal from a client terminal 3 to a server computer 1.

Average data rate R(n) which is set when compressing and creating a nth stream s(n) is calculated as follows: The number of bytes included in a compressed nth stream s(n) is b(n) which needs to be smaller than the value of [Dt(n−1)−p−c(n)]W, in which Dt(n−1) is time taken for reproducing or displaying a (n−1)th stream at a client, “p” is time taken for sending a signal from a client terminal 3 to a server computer 1, c(n) is time taken for decompressing a nth stream s(n) at a client terminal and W is an effective transmission speed of a network being used. There is additional bytes “h”, such as, header byte in a nth stream s(n) which is added separately. The average data rate R(n) which is used to compress source data to create a nth stream s(n) is set to satisfy the relationship R(n)<{[Dt(n−1)−p−c(n)]W−h}/Dt(n) in which Dt(n) is time taken for reproducing or displaying a nth stream at a client terminal.

If a particular stream s(n) is desired to have a higher quality or frame rate than other streams, an average data rate R(n) of the stream s(n) needs to be higher than an effective transmission speed W of a network being used. Therefore, an average data rate R(n−1) of a previous stream s(n−1) is set to lower than the effective transmission speed W when creating the previous stream s(n−1). Then, time Dt(n−1) taken for reproducing or displaying a stream s(n−1) is set to be longer than the sum [t(n−1)+c(n−1)] of time t(n−1) taken for sending and receiving a stream (n−1) and time c(n−1) taken for decompressing a stream (n−1). That is, the relationship Dt(n−1)>[t(n−1)+c(n−1)] should be satisfied. Accordingly, a next stream s(n) can have time t(n) taken for sending and receiving longer than time Dt(n) taken for reproducing or displaying. Therefore, an average data rate R(n) of a stream s(n) can be set higher than an effective transmission speed W of a network being used when creating the stream s(n) so that the stream s(n) has relatively high quality or frame rate.

As shown in the bottom of FIG. 3, the plurality of streams s(1), s(2), . . . , s(n) which are created as explained above can be continuously reproduced at a client terminal 3 without interruption. Actual data rate of a stream resulting from compression operation may be different from a data rate which is calculated and set as explained before. In this case, compression operation needs to be repeated until a resultant data rate after compression becomes or nears the calculated or set data rate.

Since an effective transmission speed W of a network being used may vary with environment of network, hardware and software, an effective transmission speed W is determined by testing a network to be used under actual environment of network, hardware and software.

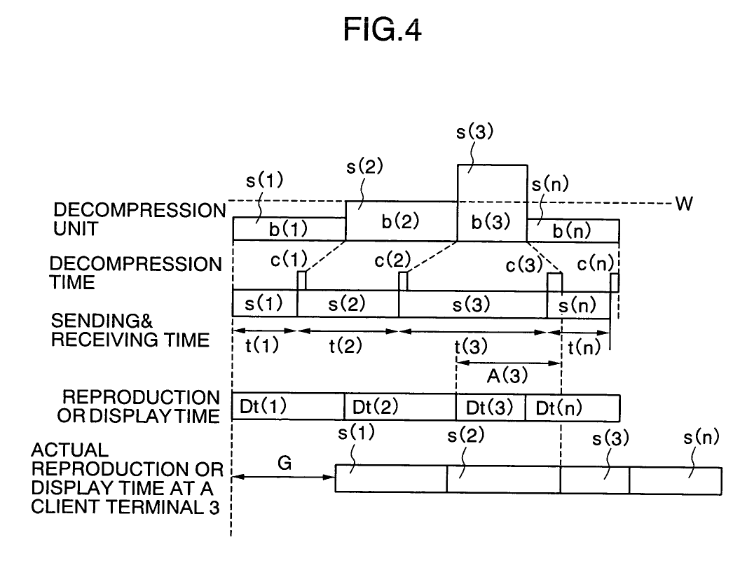

Referring now to FIG. 4, a third embodiment of the present invention is explained. In the third embodiment, there is provided a method to calculate how long streams or data are buffered after received and before reproduced at a client terminal so that streams which are compressed video and/or audio data as a whole can be decompressed stream by stream can be continuously reproduced without interruption at the client terminal.

Source video and/or audio data are compressed as a whole to average data rate set in accordance with transmission speed of a network being used. After compression, the compressed source data is divided into a plurality of parts by choosing a leading frame so that each of the parts includes one or several units for decompression(consisting of at least one frame of intraframe predictive coding and plural frames of interframe predictive coding). A header is added to each of the parts to identify each of the parts in order to make a plurality of streams. Then, the plurality of streams are sequentially sent from a server computer to a client terminal. Alternatively, if time taken for each of the units for decompression to be sent, decompressed, and reproduced is known, each of the units is sent from a server computer to a client terminal instead of the streams.

Time for buffering data at a client terminal from the start of receiving streams to the start of reproducing the streams at the client terminal is calculated hereinafter based on time taken for each of the units for decompression to be sent, decompressed, and reproduced in order to reproduce or display the streams without interruption at the client terminal.

Each of the units for decompression must be received and decompressed at a client terminal before being reproduced at the client terminal. Therefore, time taken for each of the units for decompression to be sent, received and decompressed from the start of receiving streams at a client terminal is compared with time period of reproduction from the start of reproducing streams to the unit for decompression at the client terminal, respectively. Based on the comparisons, the biggest difference between time taken for a unit for decompression to be sent, received and decompressed from the start of receiving streams at a client terminal and time period of reproduction from the start of reproducing streams to that unit for decompression at the client terminal is chosen as time for buffering data at a client terminal from the start of receiving streams to the start of reproducing the streams. Time for buffering data as chosen above can prevent reproduction of streams from being interrupted due to late sending, receiving and decompression of data.

Time for buffering data at a client terminal is described and stored in a header of a stream. A client terminal reads the time for buffering data in a header of a stream immediately after receiving the stream and set the time for buffering data into a timer. The timer counts time period from the start of receiving streams so as to buffer received data in the client terminal. If the timer reaches the time for buffering data, the client terminal starts reproduction of the streams. Time for buffering data at the client terminal is this controlled by the timer in which the calculated time for buffering data is stored.

FIG. 4 shows a method for calculating how long streams or data are buffered at a client terminal so that streams can be continuously reproduced n-1 without interruption at the client terminal. Time period

$$T ( n - 1 ) = {\sum }_{i}^{n - 1}$$

Dt(i) of reproduction from the start of reproduction of streams to a (n−1)th decompression unit s(n−1) is subtracted from sum [Tt(n)+c(n)] of time period

$$T t ( n ) = {\sum }_{i = 1}^{n}$$

t(i) from the start of receiving streams to receiving a nth decompression unit s(n) and time c(n) taken for decompressing the nth decompression unit s(n). That is, a value A(n)=[Tt(n)+c(n)−T(n−1)] is calculated for each of “n”. From the calculation, the largest value of A(n) is obtained as “g”. This largest value “g” is chosen as time for buffering data form the start of receiving streams to the start of reproducing the streams at a client terminal.

For example, as shown in FIG. 4, a decompression unit s(3) has relatively large bytes and an average data rate higher than an effective transmission speed W of a network being used. Therefore, a value A(3)=[Tt(3)+c(3)−T(2)] has the largest value “g” in FIG. 4 in which Tt(3)=t(1)+t(2)+t(3) and T(2)=Dt(1)+Dt(1). Thus, a value G>g=A(3) is chosen as time period from the start of receiving streams to the start of reproducing streams and time for buffering stream data in a client terminal. By choosing time for buffering data as explained above, a client terminal can reproduce all decompression units including the unit s(3) having a large bytes without interruption. As shown in the bottom of FIG. 4, a client terminal 3 can continuously reproduce a plurality of streams s(1), s(2), s(3), . . . , s(n) without interruption by choosing the buffering time G.

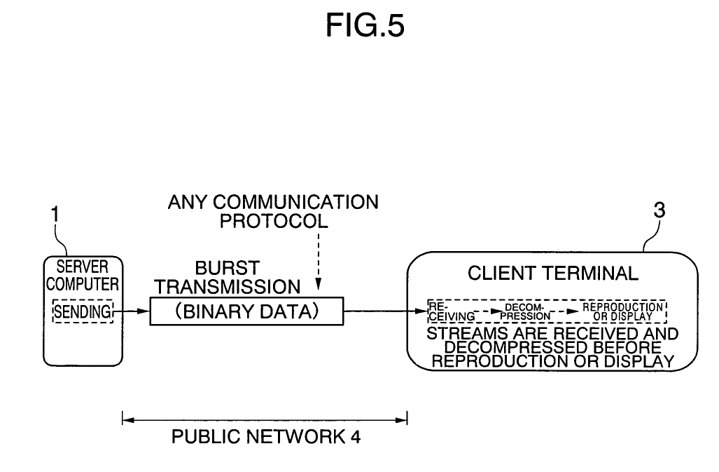

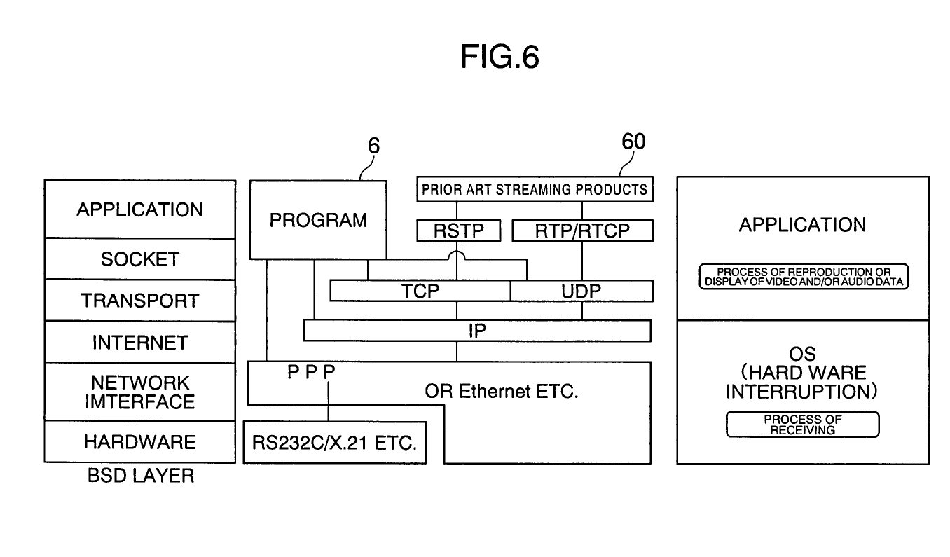

Referring now to FIG. 5 and FIG. 6, a computer program according to an embodiment of the present invention for use in delivery of multiple compressed streams of video and/or audio data from a sever computer to a client terminal, decompression and reproduction at a client terminal is explained. According to the computer program of the embodiment, each process of sending, receiving, decompressing, and reproducing is operated independently. Process of sending and receiving streams is performed like file transfer. Therefore, a conventional negotiation between a server and a client is not required. Since lower protocols alone can deal with sending and receiving streams, after a server 1 and a client 3 are connected through a network 4, streams can be immediately sent from a server to a client by only stream send instruction. Any communication protocol may be used by the present invention. For example, streams are sent to a client 3 through a conventional network by burst transmission. A client 3 can receive, decompresse, and reproduce or display streams independently of a server 1 since time taken for sending, buffering, and reproducing the streams are controlled when creating the streams compressed by variable bit rate so that the streams are continuously delivered to a client in the same way as file transfer and properly reproduced there.

The present invention is different from prior art streaming products in that prior art products need a negotiation between a server and client for each stream to make synchronization between a server and a client in the process of sending, receiving, decompressing, and reproducing or displaying and a special type of communication protocols.

FIG. 6 shows a computer program 6 according to an embodiment of the present invention located in a client terminal 3. The client computer 3 is a computer having BSD layer including from the bottom a hardware layer, a network interface layer, Internet layer, a transport layer, a socket layer and an application layer. A prior art streaming product 60 resides at the top application layer and uses protocols, such as, RSTP or RTP/RTCP, under which protocols, such as TCP/UDP or IP, resides forming multi-layered structure.

As shown in FIG. 6, a computer program 6 according to an embodiment of the present invention can use protocols, TCP/UDP, or directly use IP layer or directly use lower layer (such as, PPP or Ethernet, etc.) under which RS232C/X.21 reside. In view of this, the computer program 6 according to an embodiment of the present invention can be made effective and small so as to fit in with any network, OS, and hardware environment. The present invention can eliminate the prior art hindrance of ineffective process (due to increased number of modules by multi-layered structure and ineffective transmission (due to divisional bandwidth using one bandwidth with multiple protocols) by using a simple protocol and reducing the number of layers in order to improve effectiveness. In the computer program 6 according to an embodiment of the present invention, the process of reproducing video and/or audio data resides at the application layer and the process of receiving data resides at lower layer which can use a hardware interrupt of OS. If a client 3 is a cellular phone or personal digital assistance, a program for controlling the process of receiving streams can be incorporated into OS as a hardware interrupt by writing in a program language close to machine language, such as, assembler to improve effectiveness since process of receiving streams in a computer program 6 of the present invention have access to lower layers of protocols and good portability.

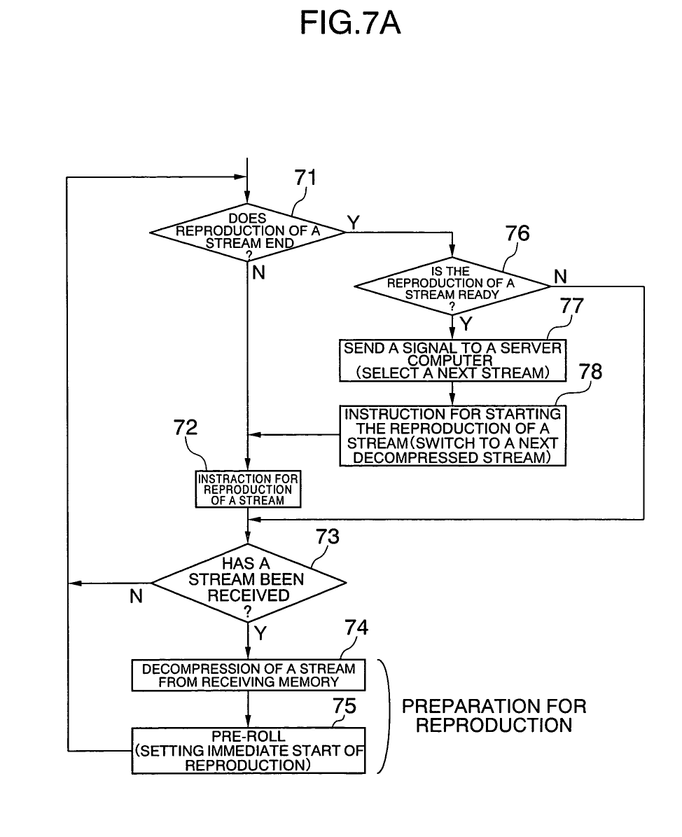

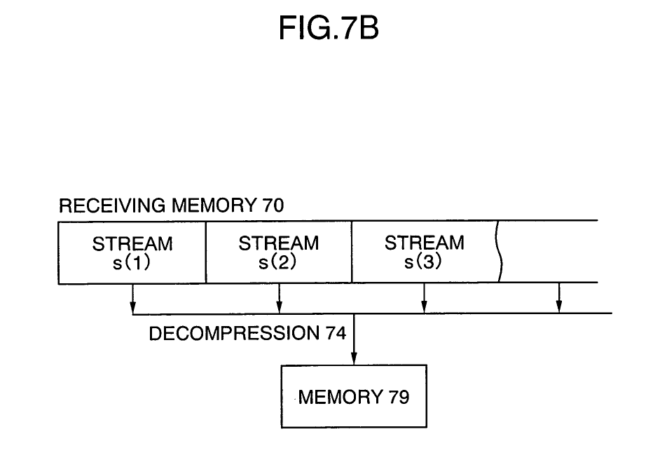

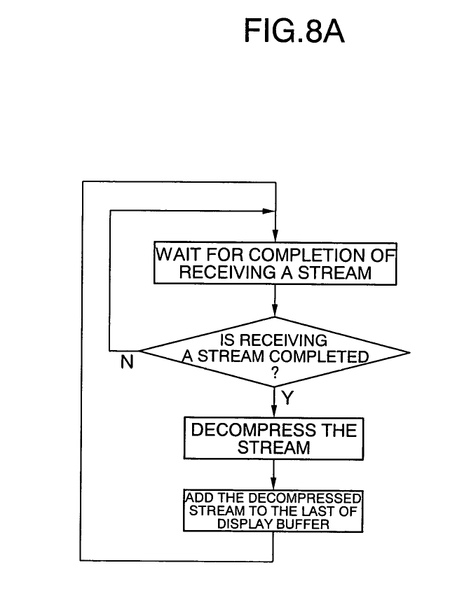

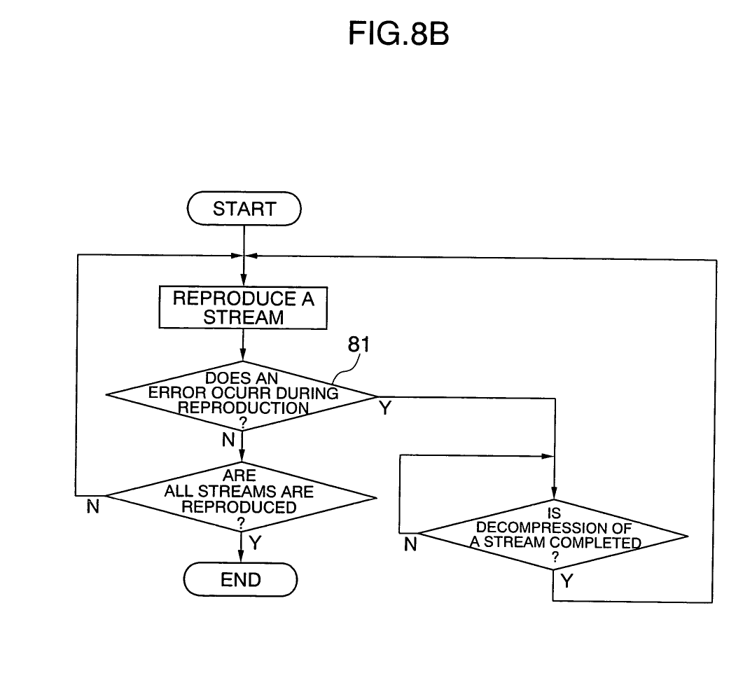

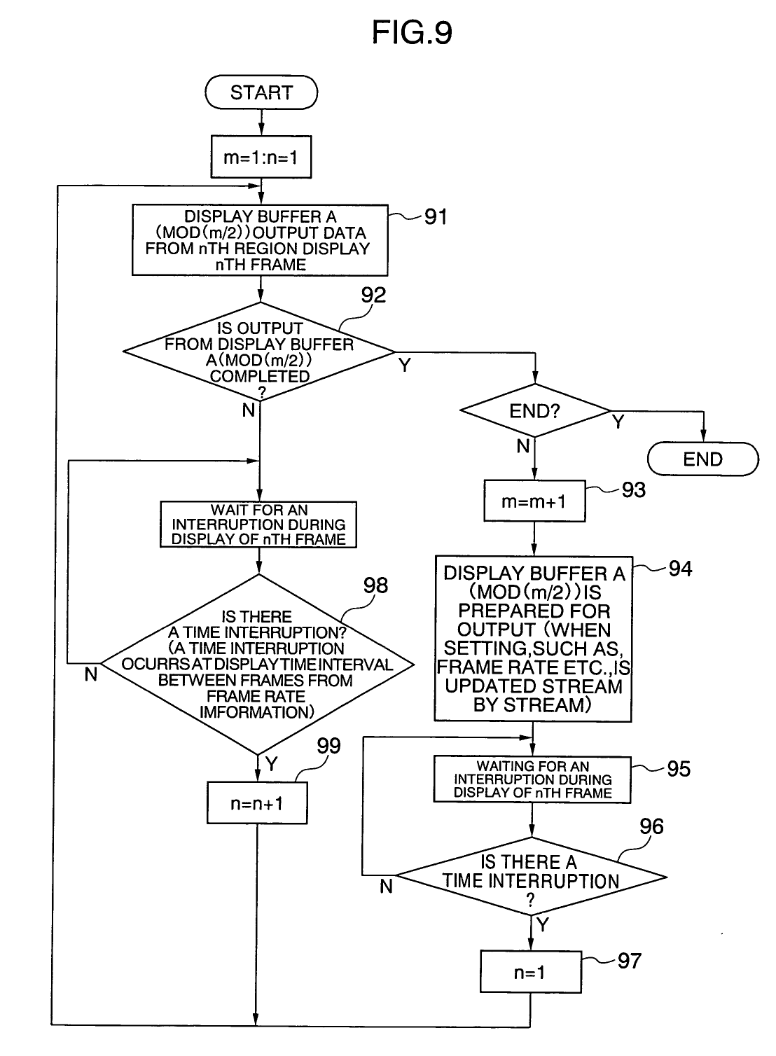

Referring to FIG. 7, FIG. 8, and FIG. 9 with the preceding drawings, each process of sending, receiving, decompressing and continuously reproducing or displaying multiple compressed streams of video and/or audio data by a computer program 6 of the present invention is explained hereinafter.

Sending and Receiving

A server computer 1 in FIG. 5 sends a stream including a number of frame data which can be decompressed alone with an identifier of several bytes at the beginning or ending of the stream to a client terminal 3 through a network. The client terminal 3 stores a received stream into a receiving memory 70 (FIG. 7B). The server 1 starts sending a next stream immediately after sending a preceding stream. Thus, the server 1 sequentially sends a plurality of streams. On the other hand, the client 3 repeats to receive the streams. The client 3 sequentially stores received streams into the receiving memory 70 (FIG. 7B) easily because the client 3 can identify a connection between the streams with the identifier even if the streams are continuously sent from the server 1. In other words, since the identifier at the beginning or ending of a stream identifies a next or previous stream connecting to that stream, the client 3 can easily stores the streams sequentially into the memory 70 (FIG. 7B).

As explained before in conjunction with FIG. 3, if sending a stream from a sever 1 is synchronized with reproducing a stream at a client 3, the client 3 sends a signal of several bytes to the server 1 when the client 3 starts or completes reproduction of a stream. Then, the server 1 starts sending a next stream when receiving the signal from the client 3. The synchronization between the server 1 sending a stream and the client 3 reproducing a stream can be attained by a simple mechanism. This prevents the client 3 from receiving excessive streams. In addition, in case of an interactive system for interactive contents, a sever computer can easily be in synchronize with a user input signal from a client.

According to the present invention, each process of sending, receiving, decompressing, and reproducing or displaying a stream is operated independently each other. Therefore, any type of compression method for compressing a stream may be used if a decompression and reproduction program at a client 3 can solely decompress and reproduce a compressed stream. In addition, if streams are sent as file with burst transmission, efficiency of transmission can be improved. A client 3 always waits for receiving a stream while receiving and reproducing streams one by one.

Decompression

Referring now to FIG. 7A and FIG. 7B, process of decompressing a stream is explained. A flowchart in FIG. 7A shows that a received stream stored in the receiving memory 70 (FIG. 7B) is decompressed stream by stream (steps 73 and 74). The decompressed stream is pre-rolled and stored into a vacant space of memory 79 (FIG. 7B) (step 75). The amount of data increases several ten times by decompression. If data stored in the memory 79 (FIG. 7B) is desired not to be too large, streams are not decompressed immediately after receiving when there is already any stream which is decompressed but not yet reproduced in the memory 79. If reproduction of a preceding stream begins, then a succeeding stream is decompressed, pre-rolled, and stored into the memory 79.

Reproduction or Display

Process of reproduction or display begins with a first stream s(1) which is firstly received, decompressed and stored in the memory 79 (step 72). Process of reproduction or display proceeds to a second stream s(2) which is secondly received, decompressed and stored in the memory 79 (step 78) immediately after completing the reproduction or display of the first stream (step 71). Actually, before step 78 for proceeding to a next decompressed stream for reproduction or display, there are step 76 for confirming the readiness of reproduction of a stream and step 77 for sending a signal to a server (in case of streams as shown in FIG. 3). Thus, process of reproduction or display proceeds to a next stream which is sequentially received, decompressed and stored. Timing for starting reproduction or display of each frame in a stream is determined by a predetermined frame rate set by header information in the stream or the like irrespective of timing of sending and receiving.

It takes longer time to connect a last frame of a preceding stream with a first stream of a next stream than connecting to frames in the same stream because an instruction to reproduce or display a first frame of a next stream is issued after a last frame of a preceding stream is reproduced or displayed. Therefore, a last frame of a stream is reproduced or displayed longer than other frames in the same stream. However, this reproduction or display time difference between a last frame and other frames in a stream is too short for a man to notice. Therefore, this difference is generally negligible for applications of video and/or audio data reproduction.

Referring now to FIG. 8A and FIG. 8B, a method for receiving, decompressing, and reproducing or displaying streams according to other embodiment of the present invention is explained. Process of receiving and decompressing streams shown in flowchart of FIG. 8A is operated in parallel with process of reproducing or displaying streams shown in flowchart of FIG. 8B. As shown in FIG. 8A, when process of receiving a stream is completed, a received stream is decompressed. Then a decompressed stream is stored into a buffer memory. Decompressed stream is sequentially added to the last position of the buffer memory. As shown in FIG. 8B, process of reproduction or display begins with the start position of the buffer memory and sequentially proceeds to decompressed data of a stream. Step 82 in FIG. 8B is an error process which occurs when data in the buffer memory run out because decompression of a next stream is not ready. In this case, the process waits for completion of process of receiving and decompressing in FIG. 8A. If two buffer memories are used in stead of using one buffer memory, process of reproducing or displaying data from one buffer memory and process of adding data into the other buffer memory of which data has been reproduced or displayed and invalidated can done alternately with respect to the two buffer memories. The two buffer memories can continuously reproduce streams without increasing memory space of buffer memories.

Each frame data of a stream is reproduced or displayed at a relatively defined certain time in that stream because each frame data from a decompressed stream is periodically reproduced or displayed in accordance with frame rate information. Therefore, when a plurality of streams are sequentially reproduced or displayed, it is possible to serially assign a relative time to be reproduced or displayed to each frame data from a first frame to a last frame throughout the plurality of the streams.

Referring now to FIG. 9, a method for serially reproducing or displaying frame data according to an embodiment of the present invention is explained. There are provided a plurality (MOD(m/2)) of display buffer memories A for alternately storing decompressed data of decompression units of a stream into either one of two display buffer memories. When it is time for reproduction or display of a last frame in a stream (step 91), one display buffer memory storing decompression data of that stream soon completes to output frame data. The completion of output from the one display buffer memory is then detected (step 92). When it is time for reproduction or display of a next stream, a first frame in a next decompressed stream which has been stored in the other display buffer memory is reproduced or displayed (from step 93 to step 97). Step 94 is process for preparing a display buffer memory A (MOD(m/2)) storing decompressed stream data if setting, such as, frame rate, is changed or updated stream by stream. Step 96 is process for interrupting in time between frame display times based on frame rate information.

Process of reproduction or display data sequentially proceeds to a second frame data and following frame data when it becomes time for reproducing or displaying each of those frames (step 98, step 99). When it becomes time for reproducing or displaying a last frame in a stream, a first frame of a decompressed next stream which has been stored in the other display buffer memory is reproduced or displayed next. In this way, by using alternately two display buffer memories, each frame data of a plurality of streams can be reproduced or displayed with correct time interval as if one stream.

Audio data and video data can be compressed and multiplexed into a stream for delivery. Audio data can be processed for decompression and reproduction in the same way as video data described above.

Streams stored in the memory 70 (FIG. 7B) of a client terminal 3 can be recorded in a hard disk drive in order for the client terminal 3 to reproduce or display the streams again and again after the client terminal 3 is disconnected from a server computer. Therefore, even if reproduction or display of streams at a client terminal is interrupted for some reasons, such as, change of transmission efficiency of a network, the client terminal can solely reproduce or display received streams later on. Thus, according to the present invention, a client terminal can start reproduction or display of streams immediately after receiving the streams and repeat the reproduction or display of the streams later on once the client terminal receives all streams.

An interactive system in which a sever computer 1 selects a stream to be sent in response to a user input from a client terminal 3 is explained.

Sequentially sending streams which are a unit for decompression process from a server to a client for sequentially reproduction at the client can improve transmission efficiency. However, process of sending a stream from a server is not synchronized with process of reproducing a stream at a client. Such synchronization is necessary for an interactive system. The present invention provides a system and method for use in an interactive system, such as, an interactive audiovisual work delivery system disclosed in Japanese Patent Application No. 10-172701 or International Patent Application No. PCT/JP/99/07116, in which if a user input his selection by a keyboard or a mouse in response to a display screen at a client terminal, a next display selected by a user is displayed.

In a system and method of the present invention, as explained before in conjunction with FIG. 3, a client terminal 3 sends a signal of several bytes to a server computer 1 each time when the client terminal starts reproduction of a stream (step 77 in FIG. 7). The server computer 1 receives this signal from the client terminal 3 and then starts process in response to the signal.

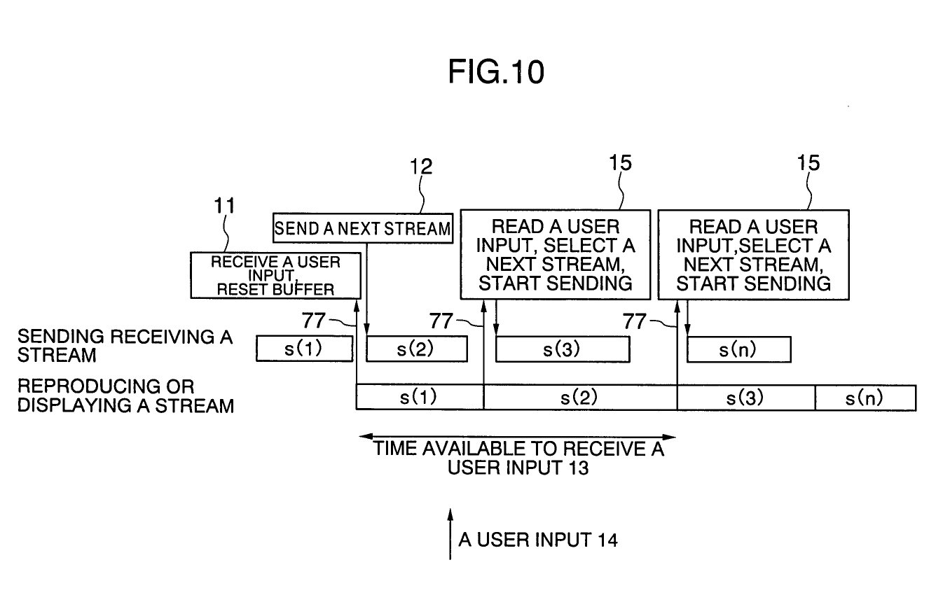

FIG. 10 discloses a system of the present invention for selecting stream by stream (FIG. 7). Every time when a client terminal 3 starts reproduction or display of each stream s(1), s(2), s(3), the client terminal 3 sends a signal 77 to a server computer 1 (step 77 in FIG. 7). When receiving the signal 77, the server computer 1 resets user input information in a receiving buffer(not shown) in order to make the receiving buffer available for a new user input (step 11) and starts sending a next stream s(2) (step 12). In response to a user input 14 for time period 13 available to receive a user input, the server computer 1 selects a next stream s(3) in order to send to the client terminal 3 (step 15). Since a user at the client terminal 3 can select a next stream to be reproduced or displayed by a user input, the user can develop his own story, reproduce or display streams in slow motion or in fast motion, play back or pause streams or trick play on a stream by interactively selecting a next stream in real time.

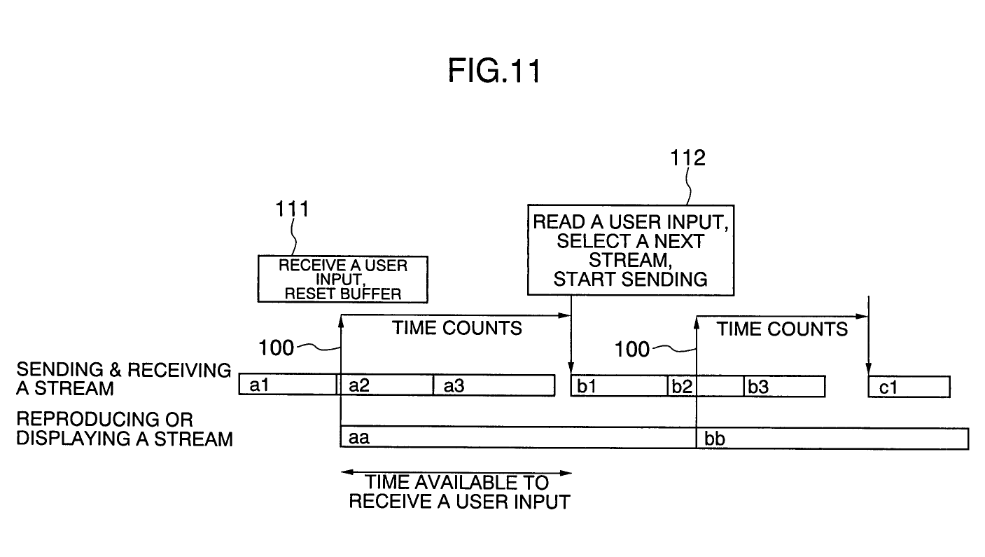

In the embodiment shown in FIGS. 8A and 8B in which received and decompressed data is sequentially added to buffer memory, it is not possible to know time for starting reproduction or display of a second and following streams (a2 or a3, b2 or b3) which is a unit for sending, receiving and decompression as shown in FIG. 11. Therefore, when a first stream in a stream aa which is a unit for sending, receiving and decompression is started to reproduce, a client terminal sends a signal 100 to a server computer 1 so that the server computer 1 resets a user input receiving buffer and starts a time counter (step 111). When the time counter counts a time period for available for a user input which is equal to time taken for reproducing or displaying a unit aa (including streams a1, a2, a3) which is a unit for sequentially sending and receiving minus time taken for selecting, sending, and decompressing a first stream b1 in a next unit bb, the server computer 1 starts sending the first stream b1 in the unit bb (step 112).

Alternatively, when a server computer receives a user input from a client terminal, the server computer immediately reads the user input, selects a next stream and sends the selected next stream to the client terminal by stopping currently sending stream. The client terminal decompresses and reproduces the selected next stream immediately after receiving it. Once the streams are stored into the memory 70 (FIG. 7) of a client terminal 3, the client terminal 3 can reproduce or display the streams again and again later on.

As explained above, a system and method of the present invention for delivery of video and/or audio data from a server to a client through a network can deliver multiple compressed streams of the video and/or audio data to continuously reproduce or display the video and/or audio data at the client by receiving, decompressing and reproducing or displaying at the client independently from the server with a simple computer program. A system and method of the present invention can also reproduce or display streams immediately after receiving them and will not wait a user for a long time. A system and method of the present invention can also reproduce or display streams again and again, once a client terminal receives the streams. A system and method of the present invention can also prevent interruption of video and/or audio during the reproduction of video and audio data through a network. A system and method of the present invention can also interactively deliver video and/or audio data through a network. A system and method of the present invention can also deliver some streams with a higher quality (in display/in sound) than other streams to a client. A system and method of the present invention can reduce the size of computer program residing at a server and a client to implement the system and method of the present invention. A computer program according to the present invention can use any and communication protocols and have high portability. A system and method of the present invention can also use any compression method as long as a compressed stream can be decompressed and reproduced solely. A system and method of the present invention can also provide high quality reproduction of video and/or audio data through a narrow bandwidth network.

### INDUSTRIAL APPLICABILITY

The present invention has an industrial applicability in the delivery of contents of video and/or audio materials through a network including a public telephone network.

1. A method for sending multiple compressed streams of video and/or audio data from a server computer to a client terminal through a network for reproducing the streams at the client terminal, comprising the steps of sequentially sending the streams from the server computer to the client terminal, sequentially receiving the sent streams at the client terminal, storing the received streams into a memory in the received order at the client terminal independently of the server computer, sequentially decompressing the stored streams, and reproducing or displaying the decompressed streams in parallel with the receiving and decompressing of the streams.

2. The method as claimed in claim 1, further comprising the steps of sending a signal from a client terminal to a sever computer each time when the reproduction or the display of a stream starts or ends at the client terminal, and when the signal is received by the server computer, the server computer starting the step of sequentially sending the compressed streams from the server computer.

3. The method as claimed in claim 1, further comprising the steps of including an identifier in each of the streams for indicating the connecting relationship between the streams, and the client terminal using the identifier when sequentially storing the streams into the memory.

4. A method for sending a plurality of compressed streams of video and/or audio data from a server computer to a client terminal through a network and reproducing the streams at the client terminal, comprising the steps of sending a first stream from the server computer to the client terminal, receiving the first stream at the client terminal, decompressing and reproducing or displaying the first stream at the client terminal immediately after the receiving the first stream, sending a second stream from the server computer immediately after sending the first stream, receiving and decompressing the second stream at the client terminal during the reproduction or display of the first stream, reproducing or displaying the second stream immediately after the reproduction or display of the first stream at the client terminal without interruption, and sequentially repeating the above steps for following streams,
wherein there are first relationship [Dt(1)+c(1)]>[t(2)+c(2)] in which Dt(1) is time taken for reproducing or displaying the first stream at the client terminal, c(1) is time taken for decompressing the first stream at the client terminal, t(2) is time taken for sending the second stream from the server computer and receiving the second stream at the client terminal, and c(2) is time taken for decompressing the second stream at the client terminal, and second relationship [t(n)+c(n)]<[T(n−1)+c(1)−T′(n−1)] in which “n” is an integer more than two, t(n) is time taken for sending a nth stream from the server computer and receiving the nth stream at the client terminal, c(n) is time taken for decompressing the nth stream, T(n−1) is time taken for reproducing or displaying from the first stream to (n−1)th stream at the client terminal, c(1) is time taken for decompressing the first stream at the client terminal, and T′(n−1) is time taken for sending the second stream through the (n−1)th stream from the server computer and receiving the second stream through the (n−1)th stream at the client terminal.

5. A method for creating multiple compressed streams of video and/or audio data to be sent from a server computer to a client terminal through a network for reproducing the streams at the client terminal, comprising the step of:
creating the streams so that a nth stream of the streams has an average data rate R(n) after compression which has relationship, R(n)≦{[T(n−1)+c(1)−c(n)]W−B(n−1)−H}/Dt(n), in which “n” is an integer more than one, T(n−1) is time taken for reproducing or displaying from a first stream through a (n−1)th stream of the streams at the client terminal, c(1) is time taken for decompressing the first stream at the client terminal, c(n) is time taken for decompressing the nth stream at the client terminal, W is an effective transmission speed of the network, B(n−1) is the number of total bytes included from a second stream to the (n−1)th stream (when n=2, B(1)=0), H is the number of additional bytes added separately, such as, header bytes, and Dt(n) is time taken for reproducing or displaying the nth stream at the client terminal.

6. A method for creating multiple compressed streams of video and/or audio data to be sent from a server computer to a client terminal through a network for reproducing one of the streams with a higher quality or higher frame rate than the other streams at the client terminal, comprising the steps of:
if a second stream is the one of streams to be reproduced with a higher quality or higher frame rate than the other streams, creating a first stream and the second stream so that an average data rate after compression of the first stream is lower than an effective transmission speed W of the network and that the value of [Dt(1)+c(1)] is large in which Dt(1) is time taken for reproducing or displaying the first stream at the client terminal and c(1) is time taken for decompressing the first stream at the client terminal in order to make an average data rate of the second stream after compression higher than the effective transmission speed W of the network, and if a nth stream of the streams (“n” is an integer more than 2) is the one stream to be reproduced with a higher quality or higher frame rate than the other streams, creating the first stream through the nth stream so that the value of [T(n−1)+c(1)−T′(n−1)] is large in which T(n−1) is time taken for reproducing or displaying from the first stream through a (n−1)th stream at the client terminal, c(1) is time taken for decompressing the first stream at the client terminal, and T′(n−1) is time taken for sending the second stream through the (n−1)th stream from the server computer and receiving them at the client terminal in order to make an average data rate of the nth stream after compression higher than the effective transmission speed W of the network.

7. A method for sending multiple compressed streams of video and/or audio data from a server computer to a client terminal through a network for reproducing the streams at the client terminal, comprising the step of sending the streams from the server computer to the client computer so that there is relationship [t(n)+c(n)]<[Dt(n−1)−p] in which “n” is an integer more than one, t(n) is time taken for sending a nth stream of the streams from the server computer and receiving the nth stream at the client terminal, c(n) is time taken for decompressing the nth stream at the client terminal, Dt(n−1) is time taken for reproducing or displaying a (n−1)th stream of the streams at the client terminal, and “p” is time taken for sending a signal from the client terminal to the server computer.

8. A method for creating multiple compressed streams of video and/or audio data to be sent from a server computer to a client terminal through a network, comprising the step of creating the streams so that there is relationship R(n)≦{Dt(n−1)−p−c(n)]W−h}/Dt(n) among the streams in which “n” is an integer more than one, R(n) is an average data rate of a nth stream of the streams after compression, Dt(n−1) is time taken for reproducing or displaying a (n−1)th stream of the streams at the client terminal, “p” is time taken for sending a signal from the client terminal to the server computer, c(n) is time taken for decompressing the nth stream, W is an effective transmission speed of the network, “h” is the number of additional bytes added separately, such as, header bytes, and Dt(n) is time taken for reproducing or displaying the nth stream at the client terminal.

9. A method for creating multiple compressed streams of video and/or audio data to be sent from a server computer to a client terminal through a network for reproducing a nth stream of the streams with a relatively high quality or relatively high frame rate at the client terminal, comprising the step of creating the streams so that there is relationship, Dt(n−1)>[t(n−1)+c(n−1)], among the streams in which “n” is an integer more than one, Dt(n−1) is time taken for reproducing or displaying a (n−1)th stream of the streams at the client terminal, t(n−1) is time taken for sending the (n−1)th stream from the server computer and receiving it at the client terminal, c(n−1) is time taken for decompressing the (n−1)th stream at the client terminal in order to make t(n) which is time taken for sending the nth stream from the server computer and receiving the nth stream at the client terminal longer than Dt(n) which is time taken for reproducing or displaying the nth stream at the client terminal.

10. A method for sending plural “n” streams of multiple compressed video and/or audio data from a server computer to a client terminal through a network for reproducing the streams at the client terminal in which “n” is an integer more than one, comprising the step of storing the streams sent from the sever computer at the client terminal for a time period equal to or longer than “g” after receiving a first stream of the streams from the server computer and before reproducing the first stream at the client terminal, wherein “g” is the largest value of differences A(n)=[Tt(n)+c(n)−T(n−1)] for all of “n” in which Tt(n) is time taken for sending the first stream through a nth stream from the server computer and receiving them at the client terminal, c(n) is time taken for decompressing the nth stream at the client terminal, and T(n−1) is time taken for reproducing or displaying the first stream through a (n−1)th stream of the streams at the client terminal.

11. A computer readable recording medium for storing computer program means to send multiple compressed streams of video and/or audio data from a server computer to a client terminal through a network for reproducing the streams at the client terminal, comprising:
computer program instructions for implementing the steps of sequentially sending the streams from the server computer to the client terminal, sequentially receiving the streams at the client terminal, storing the received streams into a memory in the received order at the client terminal independently of the server computer, decompressing sequentially the stored streams, and reproducing or displaying the decompressed streams in parallel with the receiving and decompressing of the streams.

12. The computer readable recording medium as claimed in claim 11, further comprising computer program instructions for implementing the steps of sending a signal from a client terminal to a sever computer each time when the reproduction or the display of a stream starts or ends at the client terminal, and after the signal received by the server computer, the server computer starting the step of sequentially sending the compressed stream from the server computer.

13. A computer readable recording medium for storing multiple compressed streams of video and/or audio data to be sent from a server computer to a client terminal through a network for reproducing the streams at the client terminal, comprising:
the streams which are created so that a nth stream of the streams has an average data rate R(n) after compression having the following relationship, R(n)<{[T(n−1)+c(1)−c(n)]W−B(n−1)−H}/Dt(n), in which “n” is an integer more than one, T(n−1) is time taken for reproducing or displaying from a first stream through a (n−1)th stream of the streams at the client terminal, c(1) is time taken for decompressing the first stream at the client terminal, c(n) is time taken for decompressing the nth stream at the client terminal, W is an effective transmission speed of the network, B(n−1) is the number of total bytes included from a second stream to the (n−1)th stream (when n=2, B(1)=0), H is the number of additional bytes added separately, such as, header bytes, and Dt(n) is time taken for reproducing or displaying the nth stream at the client terminal.

14. A system for sending multiple compressed streams of video and/or audio data from a server computer to a client terminal through a network for reproducing the streams at the client terminal, comprising means for sending the streams from the server computer to the client computer so that there is relationship [t(n)+c(n)]<[Dt(n−1)−p] in which “n” is an integer more than one, t(n) is time taken for sending a nth stream of the streams from the server computer and receiving the nth stream at the client terminal, c(n) is time taken for decompressing the nth stream at the client terminal, Dt(n−1) is time taken for reproducing or displaying a (n−1)th stream of the streams at the client terminal, and “p” is time taken for sending a signal from the client terminal to the server computer.

15. A system for sending plural “n” streams of multiple compressed video and/or audio data from a server computer to a client terminal through a network for reproducing the streams at the client terminal in which “n” is an integer more than one, comprising means for storing the streams sent from the sever computer at the client terminal for a time period equal to or longer than “g” after receiving a first stream of the streams from the server computer and before reproducing the first stream at the client terminal, wherein “g” is the largest value of differences A(n)=[Tt(n)+c(n)−T(n−1)] for all of “n” in which Tt(n) is time taken for sending the first stream through a nth stream from the server computer and receiving at the client terminal, c(n) is time taken for decompressing the nth stream at the client terminal, and T(n−1) is time taken for reproducing or displaying the first stream through a (n−1)th stream at the client terminal.
